(19) United States
(12) Patent Application Publication
(10) Pub. No.: US 2014/0347389 A1
(43) Pub. Date: Nov. 27, 2014

(54) MEDICAL IMAGE DISPLAY APPARATUS

(71) Applicants: KABUSHIKI KAISHA TOSHIBA, Minato-ku (JP); Toshiba Medical Systems Corporation, Otawara-shi (JP)

(72) Inventors: Yoshimasa KOBAYASHI, Nasushiobara (JP); Kyojiro NAMBU, Nasushiobara (JP); Hisanori KATO, Otawara (JP)

(73) Assignees: KABUSHIKI KAISHA TOSHIBA, Minato-ku (JP); Toshiba Medical Systems Corporation, Otawara-shi (JP)

(21) Appl. No.: 14/457,144

(22) Filed: Aug. 12, 2014

Related U.S. Application Data
(63) Continuation of application No. PCT/JP2013/077003, filed on Oct. 3, 2013.

(30) Foreign Application Priority Data
Oct. 15, 2012 (JP) 2012-228462
Oct. 2, 2013 (JP) 2013-207749

(51) Int. Cl. G06T 11/00; G09G 5/377; G06T 3/40

(52) U.S. Cl. CPC G06T 11/005; G06T 3/40; G09G 5/377; G06T 2211/40
USPC 345/629; 345/660

(57) ABSTRACT

A medical image display apparatus according to an embodiment includes an input unit, a display unit, and an image data processing unit. The input unit inputs designation of a region of interest on a first medical image obtained by imaging an object. The display unit displays, adjacently to the region of interest together with the first medical image, an enlarged medical image obtained by enlarging an image in the region of interest. The image data processing unit decides a position at which the enlarged medical image is displayed, based on a position of the region of interest on the first medical image and a position of the first medical image.

### CROSS-REFERENCE TO RELATED APPLICATIONS

This application is a Continuation application of PCT Application No. PCT/JP2013/077003, filed Oct. 3, 2013 and based upon and claiming the benefit of priority from the Japanese Patent Application No. 2012-228462, filed Oct. 15, 2012 and the Japanese Patent Application No. 2013-207749, filed Oct. 2, 2013, the entire contents of all of which are incorporated herein by reference.

### FIELD

Embodiments described herein relate generally to a medical image display apparatus which displays image data for the execution of image diagnosis.

### BACKGROUND

Imaging apparatuses which generate image data by imaging objects include mammography apparatuses which image the breasts by irradiating them with X-rays, and X-ray diagnostic apparatuses, X-ray CT apparatuses, and MRI apparatuses which image various regions such as the chests. In addition, an imaging apparatus can perform image processing by digitalizing images. The imaging apparatus can provide an image having a plurality of features by performing a plurality of types of image processing for image data (original image data) before image processing. When performing diagnosis while displaying the image data obtained by the imaging apparatus on the monitor, the user sometimes performs radiographic interpretation by comparing the image data (current image data) with image data (differently processed image data) after processing, which is obtained by image processing different from that performed for the current image data, instead of making decision by using only the current image data currently displayed on the monitor. In addition, the user sometimes performs radiographic interpretation by using the magnifying glass function of selecting a lesion region (region of interest) on current image data, and enlarging only the selected region of interest on the current image data to window-display the enlarged image data.

When the user finds a region of interest on the current image data, it is necessary to switch to differently processed image data and compare them with each other. This makes the user lose sight of the region of interest because he/she must take his/her eyes off the current image data, and take much time for diagnosis. Furthermore, using the loupe function will display enlarged image data so as to overlap the region of interest. This makes it difficult to grasp the region of interest.

### BRIEF DESCRIPTION OF THE DRAWINGS

FIG. 1 is a block diagram showing the arrangement of an image diagnostic system according to this embodiment.

FIG. 2 is a view showing an example of first and second image data stored in an image data storage unit according to this embodiment.

FIG. 3 is a view showing an example of a screen displaying the first image data and a cursor on a display unit according to this embodiment.

FIG. 4 is a view showing a frame superimposed on the first image data and the data of the same region as that on the first image data which is surrounded by the frame on the second image data according to this embodiment.

FIG. 5 is view showing an example of a screen displaying the first image data, a frame superimposed on the first image data, and different image data according to this embodiment.

FIG. 6 is a view showing an example of a screen displaying the first image data, a frame superimposed on the first image data, and enlarged different image data according to this embodiment.

FIG. 7 is a view showing an example of a screen displaying the first image data, a moved frame superimposed on the first image data, and different image data according to this embodiment.

FIG. 8 is a view showing an example of a screen displaying the first image data, a frame superimposed on the first image data and positioned on the right end portion, and different image data according to this embodiment.

FIG. 9 is a view showing an example of identifying a region through which a frame passes on the first image data as a trace according to this embodiment.

FIG. 10 is a view showing another example of identifying a region through which a frame passes on the first image data as a trace according to this embodiment.

FIG. 11 is a view showing an example of a screen displaying the first image data, a frame superimposed on the first image data, and different image data arranged on the right side of the first image data according to this embodiment.

FIG. 12 is a view showing an example of a screen displaying the first image data, a frame superimposed on the first image data, and different image data arranged on the lower side of the first image data according to this embodiment.

FIG. 13 is a view showing, on the third image data, a frame superimposed on the first image data and the data of the same region as that of the first image data which is surrounded by the frame according to this embodiment.

FIG. 14 is a view showing an example of a screen displaying the first image data, a frame superimposed on the first image data, and two different image data arranged on the right and lower sides of this image data according to this embodiment.

### DETAILED DESCRIPTION

A medical image display apparatus according to an embodiment includes an input unit, a display unit, and an image data processing unit. The input unit inputs designation of a region of interest on a first medical image obtained by imaging an object. The display unit displays, adjacently to the region of interest together with the first medical image, an enlarged medical image obtained by enlarging an image in the region of interest. The image data processing unit decides a position at which the enlarged medical image is displayed, based on a position of the region of interest on the first medical image and a position of the first medical image.

An embodiment will be described below with reference to the accompanying drawings.

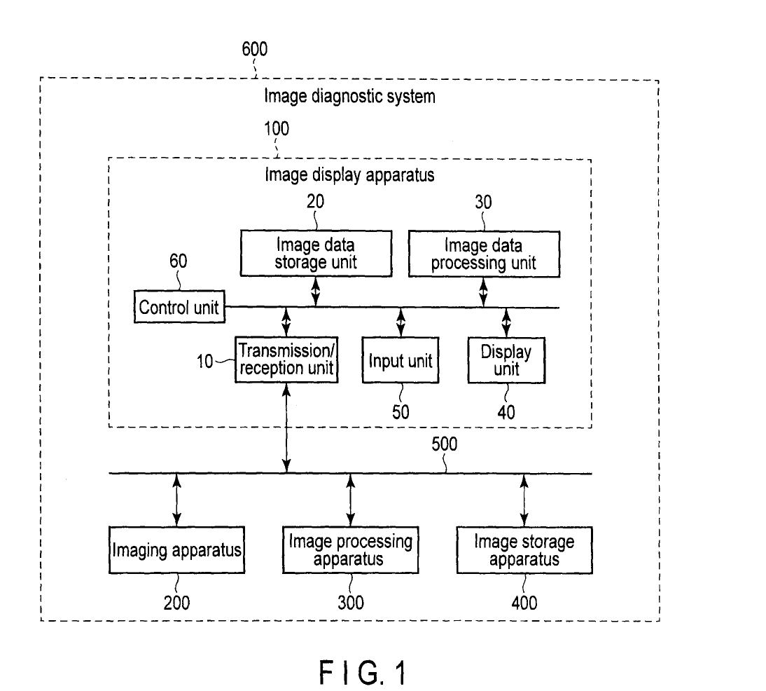

FIG. 1 is a block diagram showing the arrangement of an image diagnostic system according to the embodiment. An image diagnostic system 600 includes an imaging apparatus 200 such as a mammography apparatus or X-ray diagnostic apparatus which generates image data by imaging an object, an image processing apparatus 300 which performs image processing such as enhancement processing for the image data generated by the imaging apparatus 200 and subtraction processing between the image data of a plurality of frames, and an image storage apparatus 400 which stores the image data generated by the imaging apparatus 200 and the image data processed by the image processing apparatus 300.

The image diagnostic system 600 includes an image display apparatus (medical image display apparatus) 100 which displays the image data generated by the imaging apparatus 200, the image data processed by the image processing apparatus 300, and the image data stored in the image storage apparatus 400. The imaging apparatus 200, the image processing apparatus 300, the image storage apparatus 400, and the image display apparatus 100 transmit and receive image data via a network 500.

The image display apparatus 100 includes a transmission/reception unit 10 which transmits and receives image data to and from the imaging apparatus 200, the image processing apparatus 300, and the image storage apparatus 400, and an image data storage unit 20 which stores the image data received by the transmission/reception unit 10. The image display apparatus 100 includes an image data processing unit 30 which performs processing for displaying the image data received by the transmission/reception unit 10 from each apparatus, and the image data stored in the image data storage unit 20, and a display unit 40 which displays the image data processed by the image data processing unit 30.

The image display apparatus 100 also includes an input unit 50 including input devices such as a mouse, keyboard, and joystick for input operation to designate a region of interest on image data processed by the image data processing unit 30, input operation to display the image data processed by the image data processing unit 30 on the display unit 40, and the like, and a control unit 60 which controls the transmission/reception unit 10, the image data storage unit 20, the image data processing unit 30, and the display unit 40.

An example of the operation of the image diagnostic system 600 will be described below with reference to FIGS. 1, 2, 3, 4, 5, 6, 7, 8, 9, 10, 11, 12, 13, and 14.

The imaging apparatus 200 generates image data by imaging an object and transmits the data to the image processing apparatus 300. The image processing apparatus 300 generates the second image data (second medical image) and the third image data (third medical image) by performing two different types of image processing for the first image data (first medical image) using the image data transmitted from the imaging apparatus 200 or the image data obtained by processing this image data as image data (first image data) for diagnosis. The image processing apparatus 300 transmits the first, second, and third image data to the image storage apparatus 400. The image storage apparatus 400 stores the first, second, and third image data transmitted from the image processing apparatus 300 in association with each other. The first image data is, for example, a radiographic image.

The transmission/reception unit 10 of the image display apparatus 100 transmits request information to the image storage apparatus 400 in accordance with an input to request image data from the input unit 50. The image storage apparatus 400 transmits the first image data and the second and third image data associated with the first image data to the image display apparatus 100 in accordance with the request information from the image display apparatus 100. The transmission/reception unit 10 receives the first, second, and third image data transmitted from the image storage apparatus 400 in accordance with the transmission of the request information. The image data storage unit 20 stores the first image data and the second and third image data in association with each other. Note that the second and third image data may be images obtained by imaging an object from a plurality of angles.

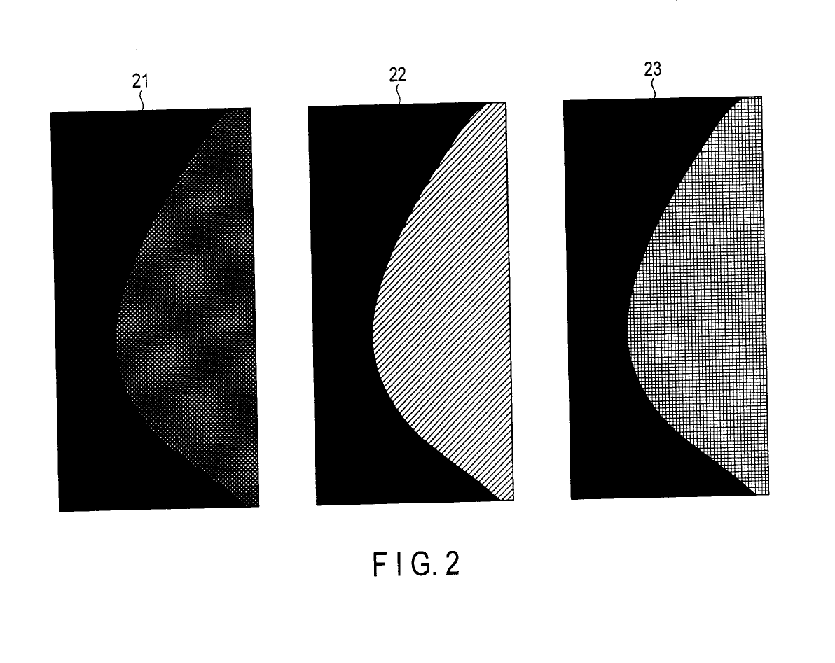

FIG. 2 is a view showing an example of the first, second, and third image data stored in the image data storage unit 20. First image data 21 is, for example, the image data generated by imaging the breast of an object which includes a lesion by the imaging apparatus 200 or the image data generated by processing this image data. In addition, second and third image data 22 and 23 (third medical images) are stored in association with the first image data 21. The second and third image data 22 and 23 are image data generated from the first image data 21 by image processing to facilitate detection of a lesion, such as the processing of enhancing the contrast between the inside and outside of the mammary gland and the processing of enhancing a calcified portion.

The user then operates the input unit 50 to perform input to set display conditions as follows: setting a display image to the first image data 21, setting a different image to the second image data 22, and setting the display mode for the different image to the superimposition display mode. In this case, the image data processing unit 30 reads out the first image data 21 from the image data storage unit 20. The image data processing unit 30 then places a movable cursor for designating a region of interest on the first image data 21. The image data processing unit 30 then arranges the first image data 21 and the cursor at predetermined positions and outputs them to the display unit 40. The display unit 40 displays the first image data 21 and the cursor output from the image data processing unit 30.

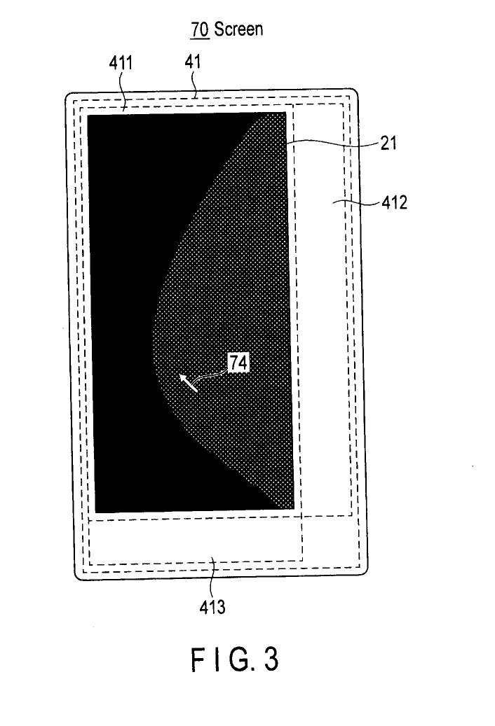

FIG. 3 is a view showing an example of a screen displaying the first image data 21 and the cursor on the display unit 40. A screen 70 includes a display area 41 for the display of the image data output from the image data processing unit 30. The display area 41 is constituted by a first display area 411 having the maximum area, a second display area 412 (outside the first display area) located adjacent to the right side of the first display area 411 and having an area smaller than that of the first display area 411, and a third display area 413 (outside the first display area) located adjacent to the lower side of the first display area 411 and having an area smaller than that of the first display area 411. The first image data 21 as a display image output from the image data processing unit 30 is displayed in the first display area 411. A cursor 74 is movably displayed on the first image data 21.

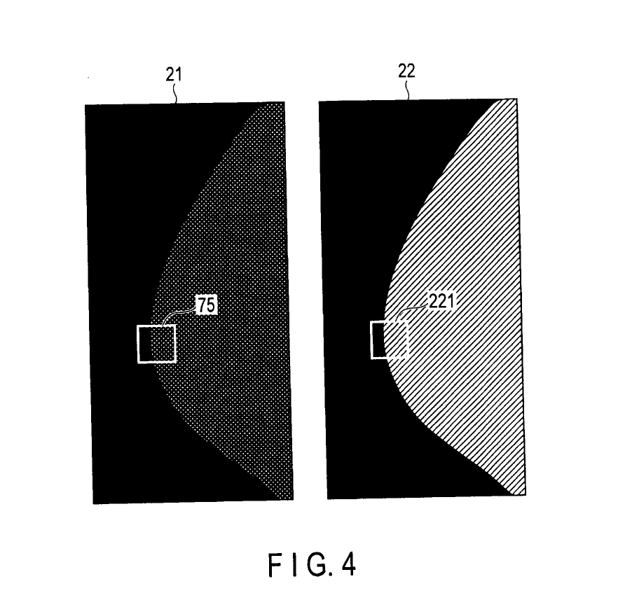

The user then operates, for example, the mouse via the input unit 50 to move the cursor 74 to a region of interest as, for example, a region of the data of a lesion on the first image data 21. In addition, when the user designates a region of interest and performs input operation for the display of a different image by pressing the left button of the mouse, the image data processing unit 30 places the first image data 21 at a position corresponding to the first display area 411. In addition, as shown in FIG. 4, the image data processing unit 30 superimposes, for example, a rectangular frame 75 surrounding the region of interest designated by an input from the input unit 50 on the first image data 21. The image data processing unit 30 also places different image data associated with the region of interest near the frame 75. For example, the image data processing unit 30 places the different image data adjacent to the frame 75 in the first display area 411. More specifically, the image data processing unit 30 places the different image data adjacent to and parallel to the frame 75 in the first display area 411.

In this case, data 221 of the same region (the same position) as the region of interest surrounded by the frame 75 on the first image data 21 is read out from the second image data 22 stored in the image data storage unit 20. The image data processing unit 30 places, adjacently to, for example, one of the four sides of the frame 75, the readout different image data obtained as a region of interest on the second image data 22 based on the superimposition display mode set as a display condition. The image data processing unit 30 places the entire region of the different image data at a position where it is superimposed on the first image data 21. The image data processing unit 30 outputs the first image data 21, the frame 75, and the different image data to the display unit 40. The display unit 40 displays the first image data 21 and the frame 75 and the different image data which are superimposed on the first image data 21.

Note that the image data processing unit 30 generates a tomosynthesis image based on the images obtained by imaging the object from a plurality of angles. More specifically, the image data processing unit 30 generates a tomosynthesis image by predetermined processing based on a plurality of images respectively corresponding to a plurality of angles relative to the object. The predetermined processing is, for example, a shift addition method or FBP (Filtered BackProjection) method. For example, the image data processing unit 30 generates a plurality of tomosynthesis images by changing a slice of the object at predetermined intervals. The image data processing unit 30 causes the image data storage unit 20 to store the generated tomosynthesis images. The image data processing unit 30 may generate different image data by using a tomosynthesis image as the second or third image data.

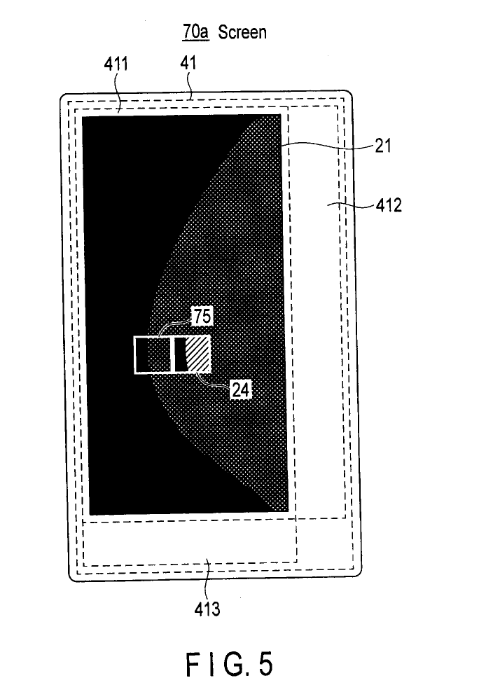

FIG. 5 is a view showing an example of displaying the first image data 21, the frame 75 superimposed on the first image data 21, and the different image data in a screen on the display unit 40. The first image data 21 is displayed in the first display area 411 in a screen 70a. In addition, the display unit 40 displays the frame 75 surrounding the region of interest superimposed on the first image data 21. In addition, the display unit 40 displays different image data 24, for example, at a position adjacent to the right side of the frame 75, at which the entire region of the different image data is superimposed on the first image data 21. In this case, the image data processing unit 30 may place the different image data 24 adjacent to any one of the upper, left, and lower sides of the frame 75 as long as the entire region of the different image data 24 is at a position where it is superimposed on the first image data 21.

Note that an enlarged medical image obtained by enlarging a region of interest on the first image data (first medical image) may be used as the above different image data. In this case, the image data processing unit 30 generates an enlarged medical image in accordance with the setting (designation) of a region of interest. For example, the image data processing unit 30 decides a position at which the enlarged medical image is to be displayed, based on the position of the region of interest on the first image data (first medical image) and the position of the first image data. Note that different image data may be image data obtained by executing tone processing, frequency processing, and the like for the first medical image.

Superimposing and displaying the frame 75 surrounding the region of interest on the first image data 21 on the display unit 40 in this manner allows the user to easily grasp the region of interest on the first image data 21. In addition, superimposing and displaying the frame 75 and the different image data 24 arranged near the frame 75 on the first image data 21 on the display unit 40 allows the user to observe the different image data 24 without losing sight of the region of interest on the first image data 21. Furthermore, since the user can observe the region of interest on the first image data 21 and the different image data 24 without changing the direction of the eyes, it is possible to easily compare the region of interest on the first image data 21 with the different image data 24.

In this case, when the user performs input operation to erase the different image by releasing the left button of the mouse of the input unit 50, the display unit 40 displays the screen 70 in FIG. 3.

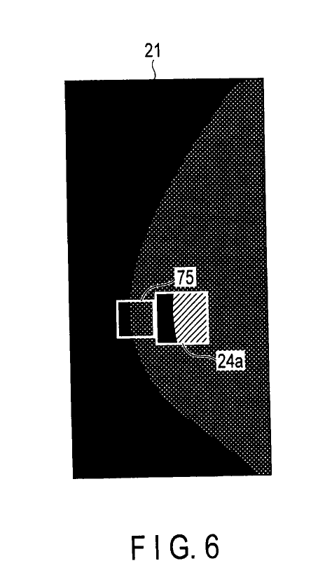

Assume that the user has input a display condition with the input unit 50 to change the different image set on the second image data 22 into an enlarged image (enlarged medical image) while the display unit 40 displays the screen 70 in FIG. 3, moved the cursor 74 to the region of interest on the first image data 21, and performed input operation to display the different image. In this case, as shown in FIG. 6, the image data processing unit 30 enlarges the different image data 24 displayed in the screen 70a in FIG. 5 to generate different image data 24a (or different image data obtained by enlarging the region of interest on the first image data 21 surrounded by the frame 75). The image data processing unit 30 then places the entire region of the different image data so as to superimpose it on the first image data 21 and place it at a position adjacent to the frame 75. The image data processing unit 30 then outputs the first image data 21, the frame 75, and the different image data 24a to display unit 40. The display unit 40 displays the first image data 21, and the frame 75 and different image data 24a which are superimposed on the first image data 21.

Superimposing and displaying the frame 75 and different image data 24a arranged near the frame 75 on the first image data 21 on the display unit 40 in this manner allows the user to observe the different image data 24a without losing sight of the region of interest on the first image data 21. In addition, since the user can observe the region of interest on the first image data 21 and the different image data 24a without changing the direction of the eyes, it is possible to easily compare the region of interest on the first image data 21 with the different image data 24a.

Subsequently, when the user performs input operation to move the frame 75 displayed in the screen 70a in FIG. 5 to, for example, a right end portion on the first image data 21 while pressing the left button of the mouse of the input unit 50, the image data processing unit 30 generates different image data by reading out, from the second image data 22, the data of the same region as that on the first image data 21 which is surrounded by the frame moved in the direction of the right end portion. The image data processing unit 30 then places the obtained different image data at a position which is adjacent to any one of the four sides of the moved frame, and superimposes its entire region on the first image data 21. The image data processing unit 30 outputs the first image data 21, the moved frame, and the different image data to the display unit 40. The display unit 40 displays the first image data 21, and the moved frame and different image data which are superimposed on the first image data 21.

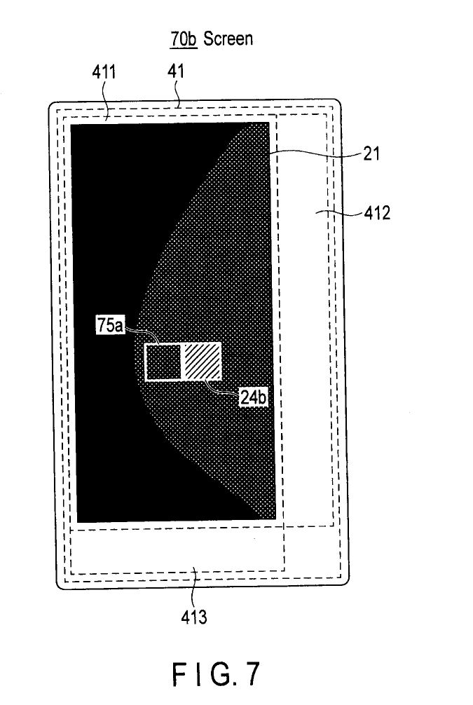

FIG. 7 is a view showing an example of displaying the first image data 21, and the moved frame and different image data which are superimposed on the first image data 21 in a screen on the display unit 40. The first image data 21 is displayed in the first display area 411 in a screen 70b. In addition, a frame 75a moved in the direction of the right end portion on the first image data 21 is displayed. The image data processing unit 30 obtains the data of the same region as that on the first image data 21 which is surrounded by the frame 75a by reading out the data from the second image data 22. The entire region of the different image data is displayed so as to be superimposed on the first image data 21 and arranged, for example, near the right side of the frame 75a.

Superimposing the moved frame 75a on the first image data 21 and displaying it on the display unit 40 in this manner allows the user to easily grasp the region of interest of the first image data 21. In addition, superimposing the moved frame 75a and different image data 24b arranged near the frame 75a on the first image data 21 and displaying them on the display unit 40 allows the user to observe the different image data 24b without losing sight of the region of interest on the first image data 21. In addition, since the user can observe the region of interest on the first image data 21 and the different image data 24b without moving the direction of the eyes, it is possible to easily compare the region of interest on the first image data 21 with the different image data 24b.

When the frame 75a reaches the right end portion of the first image data 21, the display unit 40 displays the first image data 21, and the frame and different image data which are located on the right end portion and superimposed on the first image data 21.

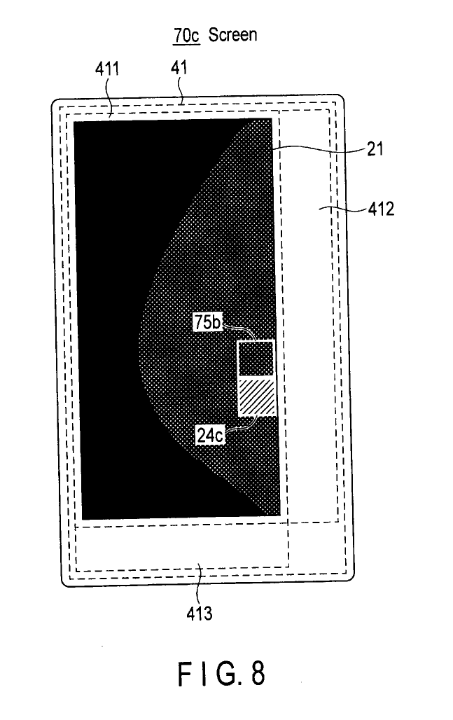

FIG. 8 is a view showing an example of displaying the first image data 21, and the frame and different image data which are located on the right end portion and superimposed on the first image data 21, in a screen on the display unit 40. The first image data 21 and a frame 75b superimposed on the first image data 21 and located on the right end portion of the first image data 21 are displayed in the first display area 411 in a screen 70c. The image data processing unit 30 obtains the data of the same region as that on the first image data 21 which is surrounded by the frame 75b by reading out the data from the second image data 22. The entire region of the different image data is superimposed and arranged on the first image data 21. With these operations, different image data 24c is displayed, for example, adjacent to the lower side of the frame 75b. Note that the display unit 40 may display the entire region of the different image data 24c so as to place it adjacent to the upper side or left side of the frame 75b which can be superimposed and arranged on the first image data 21.

Superimposing and displaying the frame 75b moved to the right end portion of the first image data 21 on the display unit 40 in this manner allows the user to easily grasp the region of interest of the first image data 21. In addition, superimposing the frame 75b located on the right end portion and the different image data 24c arranged near a side other than the right side of the frame 75b on the first image data 21 and displaying them on the display unit 40 allows the user to observe the different image data 24c without losing sight of the region of interest on the first image data 21. In addition, since the user can observe the region of interest on the first image data 21 and the different image data 24c without moving the direction of the eyes, it is possible to easily compare the region of interest on the first image data 21 with the different image data 24c.

In addition, superimposing each of the frames 75, 75a, and 75b and each of the different image data 24, 24a, 24b, and 24c on the first image data 21 can also display the image data on a display unit having the area of the first display area 411 which is smaller than the display unit 40 having the display area 41 in terms of the maximum area on which image data can be displayed.

Assume that, while the screen 70 in FIG. 3 is displayed on the display unit 40, after an operation additionally to set trace display conditions as display conditions is input from the input unit 50, an input operation to display a different image by moving the cursor 74 onto a region of interest on the first image data 21 is performed. Additionally, assume that while pressing the left button of the mouse, an input operation to move the frame 75 displayed on the screen 70a in FIG. 5 to the right end portion on the first image data 21 is performed. In this case, the image data processing unit 30 identifies, as a trace, a region through which the frame has passed on the first image data 21 from the position of the frame 75 displayed in the screen 70a to the position of the frame 75b displayed in the screen 70c in FIG. 8.

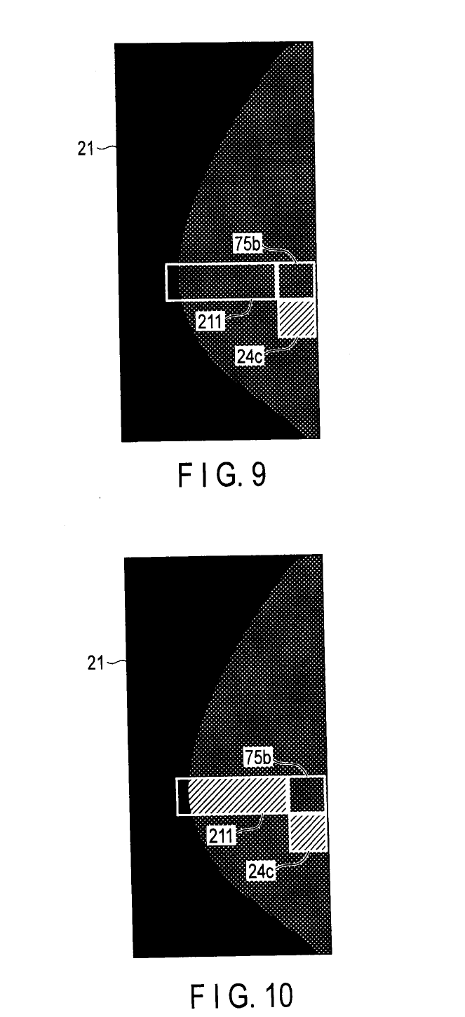

In this case, as shown in FIG. 9, the image data processing unit 30 may identify a region 211 through which a frame has passed on the first image data 21 with a color. As shown in FIG. 10, the image data processing unit 30 may identify the region 211 by superimposing the image data obtained by reading out the data of the same region as the region 211 from the second image data 22 on the first image data 21. The image data processing unit 30 then outputs the first image data 21 on which the region 211 is identified, the frame 75b, and the different image data 24c to the display unit 40. The display unit 40 displays the first image data 21 on which the region 211 is identified and the frame 75b and different image data 24c which are superimposed on the first image data 21. That is, the display unit 40 displays the region of interest (the moved region of the region of interest) input before the designation of a region of interest so as to make it identifiable with respect to the input region of interest. The display unit 40 may display, in the moved region of a region of interest, a partial region of the second image data 22 or a partial region of the third image data 23 at the same position as that of the moved region.

It is possible to prevent oversight of a region of interest which is not displayed as different image data by displaying, on the display unit 40, the region of interest on the first image data 21 on which the different image data has once been displayed, upon identifying the region of interest. It is also possible to prevent the waste of carelessly designating the same region of interest.

Assume that the user has input a display condition with the input unit 50 to change the different image display mode set to the superimposition display mode into the second display area mode while the display unit 40 displays the screen 70 in FIG. 3, and the user has moved the cursor 74 to the region of interest on the first image data 21 to perform input operation to display the different image. In this case, the image data processing unit 30 places the first image data 21 at a position corresponding to the first display area 411. In addition, the image data processing unit 30 superimposes the frame 75 surrounding the region of interest on the first image data 21. The image data processing unit 30 also reads out the data 221 of the same region as that of the first image data 21 which is surrounded by the frame 75 from the second image data 22. The image data processing unit 30 places the different image data 24 obtained as a region of interest on the second image data 22 at a position corresponding to the second display area 412 in the display area 41 on the right side of the first image data 21. The image data processing unit 30 then outputs the first image data 21, the frame 75, and the different image data 24 to the display unit 40. The display unit 40 displays the first image data 21, the frame 75 superimposed on the first image data 21, and the different image data 24 arranged on the right of the first image data.

Note that if the different image data 24 has a size large enough to protrude from the second display area 412 when being displayed, the image data processing unit 30 reduces the different image data 24 to allow its entire region to be included in the second display area 412. Assume that in the following description, the different image data 24 has a size that allows its entire region to be included in the second display area 412.

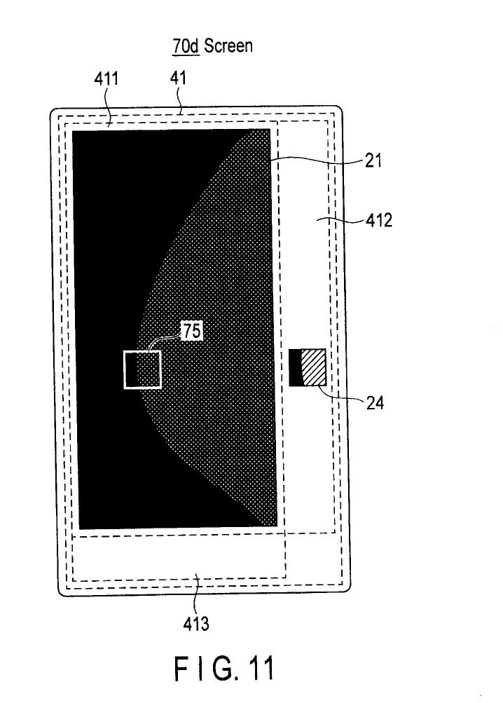

FIG. 11 is a view showing an example of a screen displaying the first image data 21, the frame 75 superimposed on the first image data 21, and the different image data 24 arranged on the right of the first image data 21 on the display unit 40. The display unit 40 displays the first image data 21 in the first display area 411 in a screen 70d and the frame 75 superimposed on the first image data 21. The display unit 40 also displays the different image data 24 in the second display area 412 on the right side of the frame 75.

In this case, when the user performs input operation to move the frame 75 to the upper side or the lower side on the first image data 21 while pressing the left button of the mouse of the input unit 50, the image data processing unit 30 reads out the data of the same region as that on the first image data 21 which is surrounded by the frame 75, which has moved to one side, from the second image data 22. The image data processing unit 30 generates different image data from the readout second image data. The image data processing unit 30 then places the data at a position synchronized to the frame 75 moved to one side of the second display area 412. The image data processing unit 30 then outputs the first image data 21, the frame 75 moved to one side, and the different image data to the display unit 40. The display unit 40 displays the first image data 21 and the frame 75 moved to one side on the first image data 21 in the first display area 411. In addition, the display unit 40 displays, in the second display area 412, the different image data associated with a region of interest which is moved in the same direction as that of the frame 75 synchronously with the frame 75 and changes synchronously with the frame 75.

In this manner, the display unit 40 displays the frame 75 surrounding the region of interest on the first image data 21 arranged in the first display area 411 and the different image data 24 arranged in the second display area 412 near the frame 75. This makes it possible to observe the different image data 24 without losing sight of the region of interest on the first image data 21. In addition, since the user can observe the region of interest on the first image data 21 and the different image data 24 without moving the direction of the eyes, it is possible to easily compare the region of interest on the first image data 21 with the different image data 24. Furthermore, since the user can observe the entire region of the first image data 21 without making the different image data 24 cover it, it is possible to easily move the frame 75 to another region of interest.

Assume next that the user has input a display condition with the input unit 50 to change and set the different image display mode set to the superimposition display mode into the third display area mode while the display unit 40 displays the screen 70 in FIG. 3, and the user has moved the cursor 74 to the region of interest on the first image data 21 to perform input operation to display the different image. In this case, the image data processing unit 30 places the first image data 21 at a position corresponding to the first display area 411. In addition, the image data processing unit 30 superimposes the frame 75 on the first image data 21. The image data processing unit 30 also places the different image data 24 at a position corresponding to the third display area 413 in the display area 41 below the first image data 21. The image data processing unit 30 then outputs the first image data 21, the frame 75, and the different image data 24 to the display unit 40. The display unit 40 displays the first image data 21, the frame 75 superimposed on the first image data 21, and the different image data 24 arranged below the first image data 21.

Note that if the different image data 24 has a size large enough to protrude from the third display area 413 when being displayed, the image data processing unit 30 reduces the different image data 24 to allow its entire region to be included in the third display area 413. Assume that in the following description, the different image data 24 has a size that allows its entire region to be included in the third display area 413.

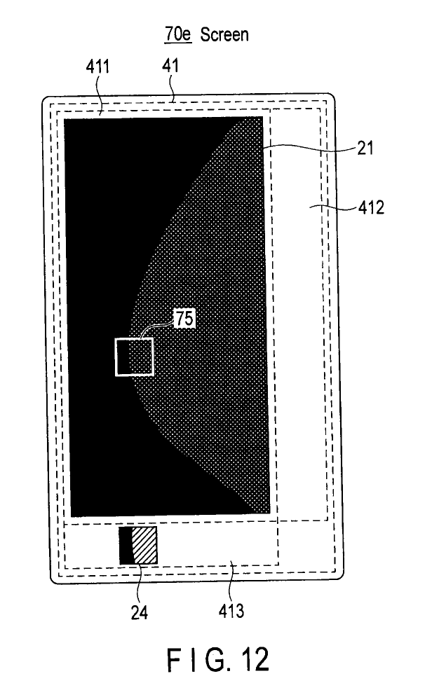

FIG. 12 is a view showing an example of displaying the first image data 21, the frame 75 superimposed on the first image data 21, and the different image data 24 arranged below the first image data 21 in a screen on the display unit 40. The display unit 40 displays the first image data 21 and the frame 75 superimposed on the first image data 21 in the first display area 411 in a screen 70e. The display unit 40 also displays the different image data 24 in the third display area 413 below the frame 75.

In this case, when the user performs input operation to move the frame 75 to the left side or the right side on the first image data 21 while pressing the left button of the mouse of the input unit 50, the image data processing unit 30 reads out the data of the same region as that on the first image data 21 which is surrounded by the frame 75, which has moved to one side, from the second image data 22. The image data processing unit 30 generates different image data from the readout second image data 22. The image data processing unit 30 then places the different image data at a position linking to the frame 75 moved to one side of the third display area 413. The image data processing unit 30 then outputs the first image data 21, the frame 75 moved to one side, and the different image data to the display unit 40. The display unit 40 displays the first image data 21 and the frame 75 moved to one side on the first image data 21 in the first display area 411. In addition, the display unit 40 displays, in third display area 413, the different image data associated with a region of interest which is moved in the same direction as that of the frame 75 synchronously with the frame 75 and changes synchronously with the frame 75.

In this manner, the display unit 40 displays the frame 75 surrounding the region of interest on the first image data 21 arranged in the first display area 411 and the different image data 24 arranged in the third display area 413 near the frame 75. This makes it possible to observe the different image data 24 without losing sight of the region of interest on the first image data 21. In addition, since the user can observe the region of interest on the first image data 21 and the different image data 24 without moving the direction of the eyes, it is possible to easily compare the region of interest on the first image data 21 with the different image data 24. Furthermore, since the user can observe the entire region of the first image data 21 without making the different image data 24 cover it, it is possible to easily move the frame 75 to another region of interest.

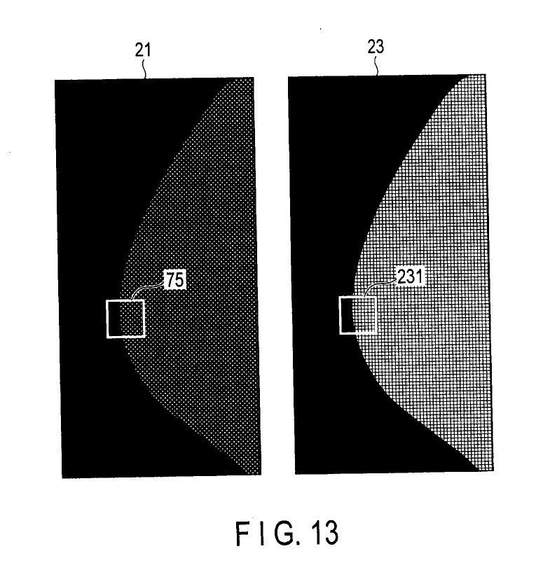

Assume next that the user has input display conditions with the input unit 50, while the display unit 40 displays the screen 70 in FIG. 3, to change and set the different image display mode set to the superimposition display mode into the second and third display area modes and change and set the different image into the second and third image data 22 and 23, and the user has moved the cursor 74 to the region of interest on the first image data 21 to perform input operation to display the different image. In this case, the image data processing unit 30 places the first image data 21 at a position corresponding to the first display area 411. In addition, the image data processing unit 30 superimposes the frame 75 on the first image data 21. The image data processing unit 30 also places the different image data 24 at a position corresponding to the second display area 412 on the right side of the first image data 21. In addition, the image data processing unit 30 reads out data 231 of the same region as the region of interest on the first image data 21 which is surrounded by the frame 75 from the third image data 23 stored in the image data storage unit 20. The image data processing unit 30 generates different image data obtained as the region of interest on the third image data 23 by using the readout third image data 23. As shown in FIG. 13, the image data processing unit 30 places the different image data at a position corresponding to the third display area 413 below the first image data 21. The image data processing unit 30 then outputs the first image data 21, the frame 75, the different image data 24, and the different image data obtained from the third image data 23 to the display unit 40. The display unit 40 displays the first image data 21, the frame 75 superimposed on the first image data 21, the different image data 24 arranged on the right side of the first image data 21, and the different image data arranged below the first image data 21.

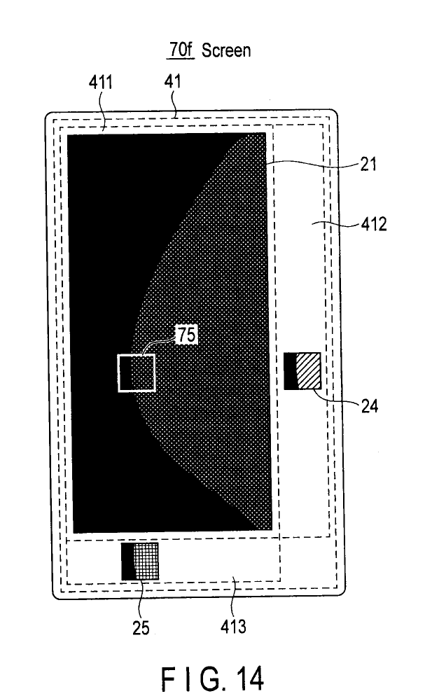

FIG. 14 is a view showing an example of displaying, in a screen on the display unit 40, the first image data 21, the frame 75 superimposed on the first image data 21, the different image data 24 arranged on the right of the first image data 21, and the different image data arranged below the first image data 21. The first image data 21 and the frame 75 superimposed on the first image data 21 are displayed in the first display area 411 in a frame 70f. In addition, the different image data 24 is displayed in the second display area 412 on the right of the frame 75. Furthermore, different image data 25 obtained from the third image data 23 is displayed in the third display area 413 below the frame 75.

In this case, when the user performs input operation to move the frame 75 to the upper side or the lower side on the first image data 21 while pressing the left button of the mouse of the input unit 50, display unit 40 displays the first image data 21 and the frame 75 moved to one side on the first image data 21 in the first display area 411. In addition, the display unit 40 displays, in the second display area 412, the different image data obtained from the second image data 22 associated with the region of interest which is moved in the same direction as that of the frame 75 synchronously with the frame 75 and changes synchronously with the frame 75. In addition, the display unit 40 displays, in the third display area 413, the different image data obtained from the third image data 23 associated with the region of interest which is stopped below the frame 75 and changes synchronously with the frame 75.

In addition, when the user performs input operation to move the frame 75 to the left side or the right side on the first image data 21 while pressing the left button of the mouse of the input unit 50, the display unit 40 displays the first image data 21 and the frame 75 moved to one side on the first image data 21 in the first display area 411. In addition, the display unit 40 displays, in the second display area 412, the different image data obtained from the second image data 22 associated with the region of interest which is stopped at the right of the frame 75 and changes synchronously with the frame 75. Furthermore, the display unit 40 displays, in the third display area 413, the different image data obtained from the third image data 23 associated with the region of interest which is moved in the same direction as that of the frame 75 synchronously with the frame 75 and changes synchronously with the frame 75.

In this manner, the display unit 40 displays the frame 75 surrounding the region of interest on the first image data 21 arranged in the first display area 411 and the two different image data 24 and 25 arranged in the second and third display areas 412 and 413 near the frame 75. This makes it possible to observe the two different image data 24 and 25 without losing sight of the region of interest on the first image data 21. In addition, since the user can observe the region of interest on the first image data 21 and the different image data 24 and 25 without moving the direction of the eyes, it is possible to easily compare the region of interest on the first image data 21 with the different image data 24 and 25. Furthermore, since the user can observe the entire region of the first image data 21 without making the different image data 24 and 25 cover it, it is possible to easily move the frame 75 to another region of interest.

According to the above embodiment, it is possible to easily grasp a region of interest on the first image data 21 by superimposing each of the frames 75, 75a, and 75b surrounding the region of interest on the first image data 21 and displaying them on the display unit 40. In addition, superimposing each of the frames 75, 75a, and 75b and each of the different image data 24, 24a, 24b, and 24c arranged near the frame on the first image data 21 and displaying them on the display unit 40 allows the user to observe each of the different image data 24, 24a, 24b, and 24c without losing sight of the region of interest on the first image data 21. In addition, since the user can observe the region of interest on the first image data 21 and each of the different image data 24, 24a, 24b, and 24c without moving the direction of the eyes, it is possible to easily compare the region of interest on the first image data 21 with each of the different image data 24, 24a, 24b, and 24c.

In addition, it is possible to easily grasp a region of interest on the first image data 21 by displaying, on the display unit 40, the frame 75 surrounding the region of interest on the first image data 21 arranged in the first display area 411 and the different image data 24 arranged in the second or third display area 412 or 413 near the frame 75 or the different image data 24 and 25 arranged in the second and third display areas 412 and 413. Furthermore, it is possible to observe the different image data 24 or the different image data 24 and 25 without losing sight of the region of interest on the first image data 21. This makes it possible to observe the region of interest on the first image data 21 and the different image data 24 or the different image data 24 and 25 without moving the direction of the eyes. It is therefore possible to easily compare the region of interest on the first image data 21 with the different image data 24 or the different image data 24 and 25. Furthermore, since it is possible to observe the entire region of the first image data 21 without being covered by the different image data 24 or the different image data 24 and 25, it is possible to easily move the frame 75 to another region of interest.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A medical image display apparatus comprising:
an input unit configured to input designation of a region of interest on a first medical image obtained by imaging an object;
a display unit configured to display, adjacently to the region of interest together with the first medical image, an enlarged medical image obtained by enlarging an image in the region of interest; and
an image data processing unit configured to decide a position at which the enlarged medical image is displayed, based on a position of the region of interest on the first medical image and a position of the first medical image.

2. The medical image display apparatus according to claim 1, wherein the display unit is configured to identifiably display a region of interest input before the designation of the region of interest on the first medical image.

3. The medical image display apparatus according to claim 1, wherein the first medical image is a radiographic image, and
the image data processing unit is configured to use, as the enlarged medical image, a tomosynthesis image based on images obtained by imaging the object from a plurality of angles.

4. The medical image display apparatus according to claim 3, wherein the display unit is configured to display, as the enlarged medical image, the tomosynthesis image obtained by changing a slice with respect to the object at predetermined intervals.

5. The medical image display apparatus according to claim 1, wherein the display unit is configured to display the enlarged medical image superimposed on the first medical image and juxtaposed with the region of interest.

6. The medical image display apparatus according to claim 1, wherein the display unit includes a first display area in which the first medical image is displayed, and
the enlarged medical image is displayed outside the first display area.

7. The medical image display apparatus according to claim 6, wherein the image data processing unit is configured to generate a second medical image and a third medical image, which are different from the first medical image, by predetermined image processing based on the first medical image,
the display unit includes the first display area, and a second display area and a third display area which are adjacent to the first display area,
the second medical image is displayed in the second display area, and
the third medical image is displayed in the third display area.

8. The medical image display apparatus according to claim 7, wherein the display unit is configured to move and display the region of interest on the first medical image in accordance with an input from the input unit, and
to identify and display a moved region obtained by moving the region of interest.

9. The medical image display apparatus according to claim 8, wherein the display unit is configured to superimpose and display on the moved region, a partial region at a same position as a position of the moved region, the partial region being included in the second medical image or the third medical image.

10. A medical image display apparatus comprising:
an input unit configured to input designation of a region of interest on a first medical image obtained by imaging an object;
a display unit configured to display, adjacently to the region of interest together with the first medical image, a second medical image associated with the first medical image, the second medical image corresponding to a position of the region of interest; and
an image data processing unit configured to decide a position at which the second medical image is displayed, based on the position of the region of interest on the first medical image and a position of the first medical image.

11. A medical image display apparatus comprising:
an input unit configured to input designation of a region of interest on a medical image obtained by imaging an object;
an image data processing unit configured to generate a tomosynthesis image based on images obtained by imaging the object from a plurality of angles and decide a position at which the tomosynthesis image is displayed, based on a position of the region of interest on the medical image and a position of the medical image; and
a display unit configured to display, adjacently to the region of interest together with the medical image, the tomosynthesis image corresponding to an image in the region of interest.
